(19) United States
(12) Patent Application Publication
(10) Pub. No.: US 2015/0016809 A1
(43) Pub. Date: Jan. 15, 2015

(54) Warming Bag for Neonate Nutritional Liquid

(71) Applicant: Angele Innovations, LLC, San Marcos, CA (US)

(72) Inventor: Janice M. Shields, San Marcos, CA (US)

(73) Assignee: Angele Innovations, LLC, San Marcos, CA (US)

(21) Appl. No.: 13/967,025

(22) Filed: Aug. 14, 2013

Related U.S. Application Data
(60) Provisional application No. 61/845,867, filed on Jul. 12, 2013.

(51) Int. Cl. A47J 36/24

(52) U.S. Cl. CPC A47J 36/2483
USPC 392/407; 206/438

(57) ABSTRACT

A sterilized system component is disclosed for holding a container of neonate nutritional liquid during a warming of the nutritional liquid. Structurally, the system component includes a pouch-shaped receptacle having a water-filled enclosure. The receptacle includes an outer bag and an inner bag. The inner bag is conformed to be received into the outer bag with the open end of the inner bag affixed to the periphery of the outer bag opening to create a permanent, fluid-tight seal. This permanent seal then creates an enclosed fluid chamber between the inner bag and the outer bag that can be filled with warm water through a fluid port that is provided in the outer bag. Prior to the warming procedure, both the receptacle and the water that is used need are sterilized using ultraviolet radiation from a germicidal lamp.

This application claims the benefit of U.S. Provisional Patent Application Ser. No. 61/845,867, filed Jul. 12, 2013. The entire contents of Application Ser. No. 61/845,867 are hereby incorporated by reference herein.

### FIELD OF THE INVENTION

The present invention pertains generally to warming bags for heating liquids. More particularly, the present invention pertains to warming bags for heating neonate nutritional liquids, including mother's milk that has somehow been preserved. The present invention is particularly, but not exclusively, useful as a warming bag that can be sterilized prior to receiving and holding a container of neonate nutritional liquid for the purpose of warming the neonate nutritional liquid.

### BACKGROUND OF THE INVENTION

Nutritional fluids for neonates (i.e. infants less than about 4 weeks old) must be served at the proper temperature and must be free of harmful bacteria. As is well known, such fluids include prepared formula as well as preserved mother's milk. In any event, the optimal serving temperature is about 97° F.; close to the temperature that breast milk is delivered directly by a mother. Since this temperature is 27° Fahrenheit above room temperature, the nutritional fluids must typically be warmed before they are administered to the neonate. During warming of the fluid, care must be taken to avoid overheating the fluid. In fact, temperatures over about 100° F. can kill enzymes, proteins, blood cells and many other components of breast milk. These temperatures can also cause destruction of other nutritional fluids. In this regard, heating techniques that rely on radiation and/or convective heat transfer tend to heat the fluid in a non-uniform and possibly dangerous manner which can cause harm to the neonate due to burns or other tissue destruction due to the mistreatment of the nutritional fluid. This non-uniform heating can often result in hot spots (i.e. portions of the fluid that are overheated), resulting in the destruction of important fluid components.

While handling the fluid, and during the warming process, it is important to ensure that bacteria is not introduced into the nutritional fluid. This is because exposure of a neonate to certain types of bacteria can cause adverse complications. One such adverse complication, necrotizing enterocolitis (NEC) occurs in about 3%-7% of all infants in neonatal intensive care units. This percentage of NEC increases as the birth weight of the neonate decreases. In more detail, NEC is an inflammatory gastrointestinal (GI) disease which causes tissue necrosis in the GI tract. Unfortunately, a large percentage of neonates that contract NEC die of the disease (in one study an NEC morbidity rate exceeding 25 percent was found).

One way to avoid the introduction of harmful bacteria is to sterilize the containers and equipment that are used to warm and administer the nutritional fluid. Known sterilization techniques include the application of heat, chemicals, irradiation or high pressure. One form of sterilization involves the use of non-ionizing ultraviolet (UV) radiation from a germicidal lamp. For this technique to be effective, the targeted bacteria must be exposed to the UV light for a minimum period of time. This exposure time is generally dependent on the intensity of the UV light being used. For the sterilization process, the UV light generated by a germicidal lamp typically has a UV-C wavelength. At these wavelengths, the light is harmful to humans. Thus, sterilization using this type of radiation must be performed inside a protective (i.e. shielded) housing.

In light of the above it is an object of the present invention to provide a system and method for warming and administering a nutritional fluid to a neonate at the proper temperature without introducing harmful bacteria. Another object of the present invention is to provide a system and method for sterilizing equipment, fluids and containers that are used to warm and administer nutritional fluids to neonates. Yet another object of the present invention is to provide a system and method for warming a neonate nutritional fluid that uses conductive heat transfer to avoid overheating the fluid. Still another object of the present invention is to provide a warming bag for neonate nutritional liquids that is easy to use and comparatively cost effective.

### SUMMARY OF THE INVENTION

In accordance with the present invention, a sterilized system component is provided to hold a container that is filled with a neonate nutritional liquid during a warming of the nutritional liquid. Importantly, as intended for the present invention, in order to achieve a uniform, controlled warming of the nutritional liquid, the container that is filled with the neonate nutritional liquid is preferably surrounded by water during the warming procedure. For the eventual protection of the neonate, both the system component and the water that is used need to be sterilized prior to the warming procedure.

Structurally, the system component of interest for the present invention is essentially a pouch-shaped receptacle that provides a water-filled enclosure. More specifically, the system component includes an outer bag having an open end and a closed end, wherein the open end defines a periphery. Further, the outer bag is formed to have a decreasing taper from its open end toward the closed end. An inner bag, which is conformed to be received into the outer bag, is also included. In their combination with each other, the open end of the inner bag is affixed to the periphery of the outer bag to create a permanent, fluid-tight seal. This permanent seal then creates an enclosed fluid chamber between the inner bag and the outer bag.

A fluid port is established to provide fluid access to the fluid chamber between the inner bag and the outer bag, through the outer bag. It is through this fluid port that the fluid chamber can be selectively filled with water, prior to a use of the system component. Preferably, the water is pre-sterilized before it is put into the fluid chamber. In either case, the water is preferably radiated and sterilized with ultraviolet (UV) light. as envisioned for the present invention, UV light for this purpose will have a wavelength, λ, of approximately two hundred fifty four nanometers (λ=254 nm).

After the system component has been sterilized and the fluid chamber is filled with sterilized water, a container filled with the neonate nutritional liquid can then be introduced into the inner bag of the pouch-shaped receptacle. A mechanical seal that is located adjacent to the periphery of the outer bag can then be manipulated to selectively enclose the container inside the inner bag during a warming of the neonate nutritional liquid. As envisioned for the present invention, the mechanical seal may either be a ridge-into-groove type connector, or an adhesive seal. Both types are well known in the pertinent art. For the adhesive seal, an adhesive material is positioned along at least 50% of the periphery of the outer bag and covered with a protective cover. In this case, the adhesive is applied to avoid a remainder portion of the periphery. Note: the remainder portion need not have an adhesive. The protective cover that is pre-positioned over the adhesive can then be selectively removed to allow the adhesive to adhere to the remainder portion.

Additional aspects for the present invention include considerations such as temperature control. On this point, during the warming procedure, the neonate nutritional liquid is preferably heated to a temperature of around 97° F., with a maximum temperature being necessarily less than 103° F. during the procedure. To warm the neonate nutritional liquid, the container filled with neonate nutritional liquid is sealed within the sterilized system component and the system component can be placed on a warming pad or within a warming receptacle. The warming pad/receptacle is then heated, for example, using ohmic heating. With this arrangement, heat conductively flows from the pad/receptacle through the water in the fluid chamber to the container filled with neonate nutritional liquid. More details regarding a suitable warming pad/receptacle for use herein can be found in U.S. application No. ______ titled “UV ADAPTER FOR PREPARATION OF NEONATE NUTRITIONAL FLUID” to Janice M. Shields, Attorney Docket Number 11634.2, filed concurrently herewith, the entire contents of which are hereby incorporated by reference herein. On another point, although any neonate nutritional liquid well known in the pertinent art may be used, the nutritional liquid is preferably selected from the group consisting of mother's milk and prepared formula.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an exploded perspective view of a system component in accordance with the present invention;

FIG. 2 is a perspective view of the system component of the present invention showing a container of neonate nutritional liquid enclosed and held within the system component by a closed mechanical seal;

FIG. 3A is a cross-section view of an embodiment of the mechanical seal as seen along the line 3-3 in FIG. 2; and

FIG. 3B is a cross-section view of an alternate embodiment of the mechanical seal shown in FIG. 3A.

### DESCRIPTION OF THE PREFERRED EMBODIMENTS

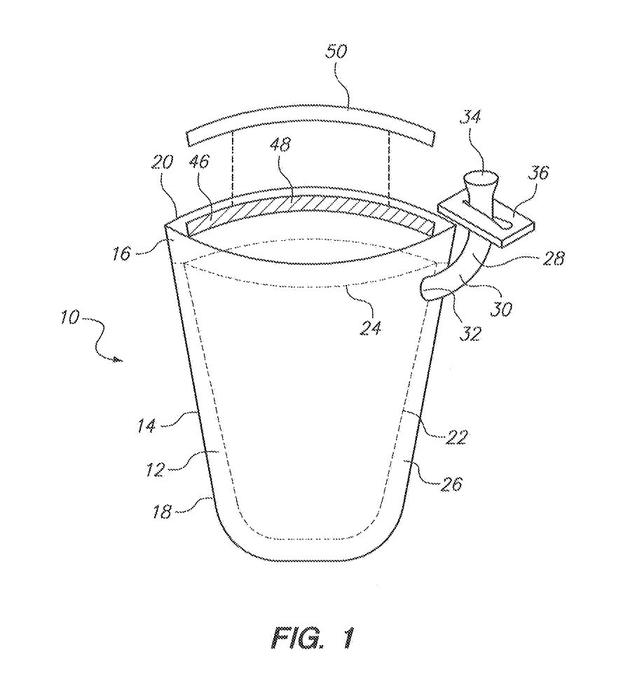

With initial reference to FIG. 1, a system component for use in warming a nutritional liquid for a neonate in accordance with the present invention is shown and generally designated 10. As shown, the system component 10 includes a pouch-shaped receptacle 12 that includes an outer bag 14 having an open end 16 and a closed end 18. As further shown, the open end 16 of the outer bag 14 defines a periphery 20 and the outer bag 14 is formed to have a decreasing taper from its open end 16 toward its closed end 18.

Continuing with FIG. 1, it can be seen that the receptacle 12 includes an inner bag 22, which is conformed to be received into the outer bag 14. With this structural combination, the open end 24 of the inner bag 22 can be affixed to the periphery 20 of the outer bag 14 to create a permanent, fluid-tight seal. This permanent seal then creates an enclosed fluid chamber 26 between the inner bag 22 and the outer bag 14.

FIG. 1 further shows that a fluid port 28 is established to provide fluid access to the fluid chamber 26 between the inner bag 22 and the outer bag 14. As shown, the fluid port includes a tube 30, or similar type structure, which passes through the outer bag 14 and has a first end 32 connected in fluid communication with the fluid chamber 26, and a second end 34. It can be further seen that a clamp 36 can be engaged at the second end 34 of the tube 30 to establish a fluid seal for the tube 30. With this structure, the clamp 36 can initially be disengaged to establish fluid access through the tube 30 and into the fluid chamber 26. It is through this fluid port 28 that the fluid chamber 26 can be filled with sterilized water, prior to a use of the system component 10. As noted above, water for the pouch-shaped receptacle 12 can be radiated and sterilized with ultraviolet (UV) light in a sterilizing housing 38. For the present invention, UV light for this purpose will have a wavelength, λ, of approximately two hundred fifty four nanometers (λ=254 nm).

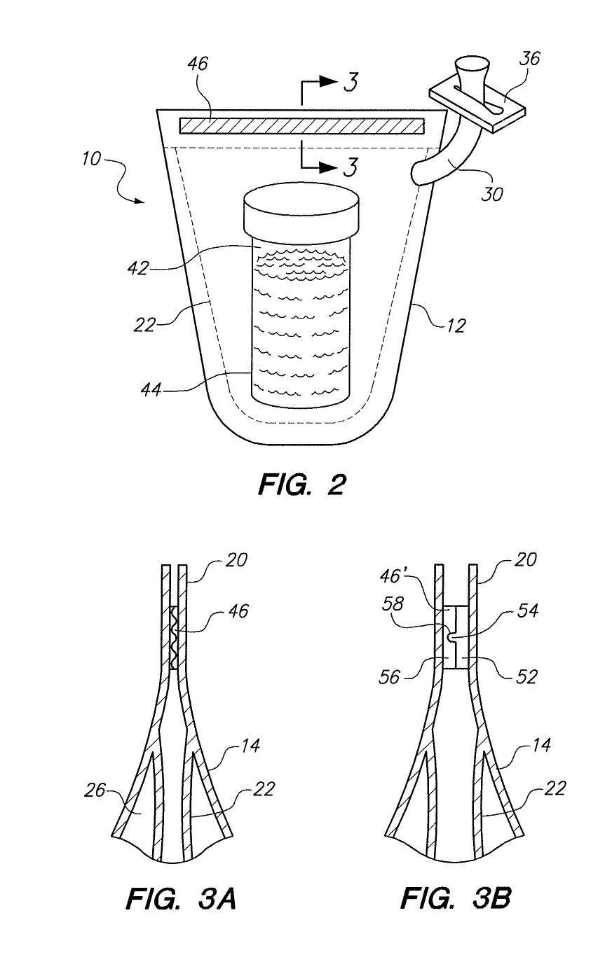

FIG. 2 indicates that after the system component 10 has been sterilized, the clamp 36 may be used to permanently seal the tube 30. A container 42 filled with the neonate nutritional liquid 44 can then be introduced into the inner bag 22 of the pouch-shaped receptacle 12. For example, the neonate nutritional liquid 44 can be any neonate nutritional liquid known in the pertinent art including, but not limited to mother's milk and prepared formula.

Referring back to FIG. 1, it can be seen that a mechanical seal 46 that is located adjacent to the periphery 20 of the outer bag 14 can be manipulated to selectively enclose the container 42 (FIG. 2) inside the inner bag 22 during a warming of the neonate nutritional liquid 44. As shown in FIGS. 1 and 3A, the mechanical seal can be an adhesive seal. For the adhesive seal, in order to achieve a complete seal for enclosing the container when the periphery 20 is closed on itself, an adhesive material 48 is positioned along at least 50% of the periphery 20 of the outer bag 14. In this case, the adhesive material 48 is positioned to avoid a remainder portion of the periphery. As shown in FIG. 1, a protective cover 50 that is positioned over the adhesive material 48 can then be selectively removed to allow the adhesive material 48 to adhere to the remainder portion.

FIG. 3B illustrates an alternate embodiment of a mechanical seal 46′ having a ridge-into-groove type connector, sometimes referred to as a ‘sliderless plastic zipper’. As shown, seal 46′ includes a first component 52 that is formed with a ridge 54. As shown, first component 52 is attached to the outer bag 14 at the periphery 20. Also for the seal 46′, a second component 56 is included have a groove 58 for receiving the ridge 54. Second component 56 is also attached to the outer bag 14 at the periphery 20.

After the liquid 44 has been properly warmed the seal 46 (46′) of system component 10 can be released, and the container 42 removed from the inner bag 22. Warm liquid 44 can then be fed to a neonate (not shown). For embodiments of the present invention that provide a clamp 36 which establishes a permanent seal for the tube structure 30, the entire system component 10 can be reused several times, as desired. It can then be simply discarded.

While the particular Warming Bag for Neonate Nutritional Liquid as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A sterilized component, used in a system for warming a neonate nutritional liquid, which comprises:
an outer bag having an open end and a closed end, wherein the open end defines a periphery, and wherein the outer bag has a decreasing taper from the open end toward the closed end;
an inner bag having an open end and a closed end, wherein the inner bag is conformed to be received into the outer bag, and wherein the open end of the inner bag is affixed to the periphery of the open end of the outer bag in a fluid tight seal to create an enclosed fluid chamber between the inner bag and the outer bag;
a fluid port established to access the fluid chamber through the outer bag for use in filling the fluid chamber with water; and
a mechanical seal located adjacent the periphery of the outer bag to selectively enclose a container filled with the neonate nutritional liquid, inside the inner bag during a warming procedure.

2. A system component as recited in claim 1 wherein a material for the outer bag is UV transparent.

3. A system component as recited in claim 1 wherein the mechanical seal is a ridge-into-groove connector.

4. A system component as recited in claim 1 wherein the mechanical seal comprises:
an adhesive positioned along at least 50% of the periphery of the outer bag, with the adhesive being positioned to avoid a remainder portion of the periphery; and
a protective cover positioned over the adhesive for selective removal therefrom to allow the adhesive to adhere to the remainder portion.

5. A system component as recited in claim 1 further comprising a means for radiating and sterilizing the water in the fluid chamber with ultraviolet (UV) light and wherein the sterilizing UV light has a wavelength, λ, of approximately 254 nm.

6. A system component as recited in claim 1 wherein the warming procedure heats the neonate nutritional liquid into a temperature range of around 97° F., with a maximum temperature of less than 103° F. during the procedure.

7. A system component as recited in claim 1 wherein the fluid port comprises:
a tube-like structure having a first end and a second end, with the first end connected in fluid communication with the fluid chamber; and
a clamp engaged at the second end of the tube to establish a fluid seal for the tube, wherein the clamp is selectively disengaged to establish fluid access through the tube and into the fluid chamber.

8. A system component as recited in claim 1 wherein the neonate nutritional liquid is selected from the group consisting of mother's milk and prepared formula.

9. An ultraviolet (UV) sterilizable component for warming a neonate nutritional liquid, the component comprising:
an outer bag made of a UV transparent plastic, the outer bag having an open end and a closed end, wherein the open end defines a periphery,
an inner bag made of a UV transparent plastic, the inner bag having an open end and a closed end, wherein the inner bag is conformed to be received into the outer bag, and wherein the open end of the inner bag is affixed to the periphery of the open end of the outer bag in a fluid tight seal to create an enclosed fluid chamber between the inner bag and the outer bag;
a fluid port made of a UV transparent plastic, the fluid port established to access the fluid chamber through the outer bag for use in filling the fluid chamber with water; and
a mechanical seal located adjacent the periphery of the outer bag to selectively enclose a container filled with the neonate nutritional liquid, inside the inner bag during a warming procedure in which heat is conducted from the water to the neonate nutritional liquid.

10. A component as recited in claim 9 wherein the mechanical seal is a ridge-into-groove connector.

11. A component as recited in claim 9 wherein the mechanical seal comprises:
an adhesive positioned along at least 50% of the periphery of the outer bag, with the adhesive being positioned to avoid a remainder portion of the periphery; and
a protective cover positioned over the adhesive for selective removal therefrom to allow the adhesive to adhere to the remainder portion.

12. A component as recited in claim 9 wherein the warming procedure heats the neonate nutritional liquid into a temperature range of around 97° F., with a maximum temperature of less than 103° F. during the procedure.

13. A component as recited in claim 9 wherein the fluid port comprises:
a tube having a first end and a second end, with the first end connected in fluid communication with the fluid chamber; and
a clamp engaged at the second end of the tube to establish a fluid seal for the tube, wherein the clamp is selectively disengaged to establish fluid access through the tube and into the fluid chamber.

14. A component as recited in claim 9 wherein the neonate nutritional liquid is selected from the group consisting of mother's milk and prepared formula.

15. A method for warming a neonate nutritional liquid, which comprises the steps of:
providing a receptacle including an outer bag having an open end and a closed end, wherein the open end defines a periphery, and wherein the outer bag has a decreasing taper from the open end toward the closed end; an inner bag having an open end and a closed end, wherein the inner bag is conformed to be received into the outer bag, and wherein the open end of the inner bag is affixed to the periphery of the open end of the outer bag in a fluid tight seal to create an enclosed fluid chamber between the inner bag and the outer bag; a fluid port established to access the fluid chamber through the outer bag; and a mechanical seal located adjacent the periphery of the outer bag;
heating water to a desired warming temperature;
filling the fluid chamber with water through the fluid port;
radiating the water and receptacle with ultraviolet (UV) light to sterilize the water and receptacle;
placing a container filled with the neonate nutritional liquid inside the inner bag; and
using the mechanical seal to seal the outer bag.

16. A method as recited in claim 15 wherein a material for the outer bag is UV transparent.

17. A method as recited in claim 15 wherein the mechanical seal is a ridge-into-groove connector.

18. A method as recited in claim 15 wherein the mechanical seal comprises:
an adhesive positioned along at least 50% of the periphery of the outer bag, with the adhesive being positioned to avoid a remainder portion of the periphery; and
a protective cover positioned over the adhesive for selective removal therefrom to allow the adhesive to adhere to the remainder portion.

19. A method as recited in claim 15 wherein the sterilizing UV light has a wavelength, λ, of approximately 254 nm.

20. A method as recited in claim 15 wherein the desired warming temperature is in a temperature range between 97° F. and 103° F.
